(19) United States
(12) Patent Application Publication
(10) Pub. No.: US 2016/0249642 A1
(43) Pub. Date: Sep. 1, 2016

(54) METHOD FOR DRYING BIOMASS

(71) Applicant: Evonik Degussa GmbH, Essen (DE)

(72) Inventors: Christian Rabe, Grossostheim (DE); Hans Christian Alt, Gelnhausen (DE); Frank Fischer, Hofheim (DE); Stefan Eils, Gründau (DE); Horst Priefert, Ostbevern (DE); Michael Diehl, Frankfurt (DE)

(73) Assignee: Evonik Degussa GmbH, Essen (DE)

(21) Appl. No.: 15/027,429

(22) PCT Filed: Oct. 1, 2014
(86) PCT No.: PCT/EP2014/071002

§ 371 Date: Apr. 5, 2016

(30) Foreign Application Priority Data
Oct. 8, 2013 (EP) 13187631.0

(51) Int. Cl. A23K 10/12; A23K 20/158; A23K 20/28; C11B 3/16; C11B 5/00

(52) U.S. Cl. CPC A23K 10/12; C11B 3/16; C11B 5/00; A23K 20/28; A23K 20/158

(57) ABSTRACT

It has been found in accordance with the invention that a biomass comprising an oxidation-sensitive material of value may be particularly readily converted into a particulate, flowable composition if a silica, especially a hydrophilic or hydrophobic silica, is added as additive.

The present invention relates to a method for drying of a biomass, containing an oxidation-sensitive material of value, and also the biomass obtainable by this method.

The importance of microbial cells for producing materials of value is well known to those skilled in the art. An example of such materials of value are foodstuff components, in particular lipids, such as, for example, polyunsaturated fatty acids. A particular role is played in the production of such materials of value not only by bacteria and yeasts, but in particular also by other fungi and by algae.

Certain materials of value, in particular polyunsaturated fatty acids (PUFAs), are an important component for the nutrition of humans and animals. The source originally used for omega-3 fatty acids was mostly fish. Later, it was discovered that certain microorganisms are heterotrophic producers of omega-3 fatty acids in large amounts, it being possible to influence, in an advantageous manner, the fatty acid production by selecting specific reaction parameters. Thereafter, the omega-3 fatty acids may be obtained from the cells, or else the cells may be employed directly in feedstuffs or foodstuffs in the form of biomass.

To process the biomass for use in feedstuffs or foodstuffs or for the subsequent isolation of the material of value, it is necessary to convert the biomass into an easy to manage, flowable form.

It has been found, however, that the work-up of the biomass described in the prior art frequently leads to a poorly manageable, non-flowable, generally hygroscopic product. This is especially the case if the biomass comprises a high proportion of lipids, particularly triglycerides.

It was an object of the present invention, therefore, to provide a method that allows the conversion of the biomass obtained into a more manageable, flowable, non-hygroscopic defined particulate product.

Particularly during the work-up, the material of value obtained should also remain very largely in intact form. In this respect, the work-up should also in particular ensure that the cell membranes of the cells present in the biomass remain very largely in intact form, in order to prevent the oxidative degradation of the material of value present. Furthermore, it should preferably also be prevented as far as possible that any liberated material of value is damaged, for example, by oxidative degradation.

It has been found in accordance with the invention, that the object according to the invention may be achieved by using silica as additive during the work-up of the fermentation broth comprising the biomass to produce a particulate composition, where the use of hydrophilic and hydrophobic silicas has emerged as particularly advantageous.

The use of silica in the preparation of the particulate composition starting from the fermentation broth leads to a clearly defined, very easy to manage, flowable, non-hygroscopic product which is both very suitable for incorporation into feedstuffs or foodstuffs, may be very readily further processed to particles having a defined particle diameter and may also be very readily used for the isolation of the material of value present from this product.

In addition, any material of value liberated is absorbed by the silica and thereby protected from oxidative degradation.

The present invention therefore firstly relates to the preparation of a particulate free-flowing biomass comprising an oxidation-sensitive material of value, characterized in that silica is used as additive during the preparation of the particulate biomass, wherein the silica is preferably a hydrophilic or a hydrophobic silica and wherein the silica is used in an amount such that a concentration of silica in the particulate biomass of 0.1 to 8% by weight is established.

The present invention therefore preferentially relates to the preparation of a particulate free-flowing biomass comprising an oxidation-sensitive material of value, characterized in that hydrophilic silica is used as additive during the preparation of the particulate biomass, wherein the hydrophilic silica is used in an amount such that a concentration of hydrophilic silica in the particulate biomass of 0.1 to 8% by weight is established.

The present invention therefore further preferentially also relates to the preparation of a particulate free-flowing biomass comprising an oxidation-sensitive material of value, characterized in that hydrophobic silica is used as additive during the preparation of the particulate biomass, wherein the hydrophobic silica is used in an amount such that a concentration of hydrophobic silica in the particulate biomass of 0.1 to 8% by weight is established.

The present invention therefore further relates also to a particulate free-flowing biomass comprising an oxidation-sensitive material of value, characterized in that the particulate biomass comprises silica, preferably a hydrophilic silica or a hydrophobic silica.

The present invention therefore also preferentially relates to a particulate free-flowing biomass comprising an oxidation-sensitive material of value, characterized in that the particulate biomass comprises hydrophilic silica.

The present invention therefore also preferentially relates to a particulate free-flowing biomass comprising an oxidation-sensitive material of value, characterized in that the particulate biomass comprises hydrophobic silica.

The present invention further relates also to the use of a particulate biomass according to the invention for preparing foodstuff or feedstuff.

The present invention therefore further relates also to foodstuff or feedstuff, characterized in that said foodstuff or feedstuff comprises a particulate biomass according to the invention.

The present invention therefore further relates also to a method for preparing foodstuff or feedstuff in accordance with the invention, characterized in that a particulate biomass according to the invention is mixed with further foodstuff or feedstuff ingredients.

The present invention further relates also to the use of a particulate biomass according to the invention for isolating the material of value obtained therein.

The present invention further relates also to a method for isolating a material of value in which a particulate biomass according to the invention is used.

The particulate free-flowing biomass according to the invention is prepared preferably starting from a fermentation broth comprising the biomass.

In order to convert the biomass from the fermentation broth into a particulate free-flowing composition, the biomass must be dried. Before actually drying the biomass, the fermentation broth comprising the biomass may also be initially concentrated to increase the solids content prior to the actual drying. However, prior concentration is not strictly necessary.

The fermentation broth is dried to give a particulate composition according to the invention, preferably by a thermal process, particularly by spray drying, drum drying or fluidized bed granulation.

The silica may optionally already be present in the fermentation broth or else may be added before concentrating and/or drying of the fermentation broth. Alternatively, the silica can also be added to the biomass only after the drying process in a further method step.

In a preferred embodiment, the silica is mixed with the fermentation broth or the still moist biomass during the drying step or in the course of the drying process. In this case, the silica is preferably metered into the drying zone using a nozzle, preferably a two-fluid nozzle. Here, the silica may be metered in in suspended form, but is preferably metered in in dry form, particularly in powder form.

The drying zone, in which the silica is preferably metered in, constitutes the fluidized bed in the fluidized bed granulation. In the nozzle spray drying process, the drying zone corresponds to the zone below the spray nozzle through which the fermentation broth is metered in. In the fluidized bed granulation and drum drying process, the drying zone corresponds to the fluidized bed or the drum.

Alternatively, the silica may also be already present in part in the fermentation broth and further additional silica is metered in in the course of the drying process.

In a further preferred embodiment, the silica is converted with the silica in an additional method step only after the drying step, i.e. only after drying the biomass preferably by spray-drying, drum drying or fluidized bed granulation. This is preferably carried out in a mechanical mixing process, for example, using a continuous mixer or a batch mixer.

Hydrophilic silicas are registered under CAS No. 112926-00-8 and are commercially available for example under the trade name Sipernat® (Evonik Industries, Germany).

Hydrophilic silicas preferably used according to the invention have a specific surface area (ISO 9277) of 130 to 600 m²/g, preferably 160 to 550 m²/g, and preferably have a dioctyl adipate absorption value of 1.5-4.0 ml/g, preferably 2.0-3.2 ml/g.

They preferably also have a tamped density (unsieved; based on ISO 787-11) of 80 to 300 g/l, preferably 100 to 270 g/l.

The particle size of the hydrophilic silica (d50; laser diffraction; based on ISO 13320-1) is preferably 10 to 150 μm, particularly 15 to 130 μm.

Loss on drying of the hydrophilic silica (2 hours at 105° C.; based on ISO 787-2) is preferably at most 10%, particularly preferably at most 7%.

Ignition loss of the hydrophobic silica (2 hours at 1000° C.; based on ISO 3262-1) is preferably at most 10%, particularly preferably at most 6%.

The silicon dioxide content of the hydrophilic silica is preferably at least 95% by weight, particularly preferably at least 97% by weight (based on ISO 3262-19).

The pH of the hydrophilic silica (5% in water; based on ISO 787-9) is preferably from 5.0 to 7.0, particularly preferably from 6.0 to 6.5.

In a particularly preferred embodiment according to the invention, the hydrophilic silica is a product having a specific surface area of 160 to 220 m²/g, a dioctyl adipate absorption value of 2.0-2.8 ml/g, a tamped density of 200 to 300 g/l and a particle size of 100 to 150 μm. Such a product is obtainable commercially under the name of Sipernat® 22 S (Evonik Industries, Germany).

In a further particularly preferred embodiment according to the invention, the hydrophilic silica is a product having a specific surface area of 450 to 550 m²/g, a dioctyl adipate absorption value of 2.5-3.5 ml/g, a tamped density of 80 to 130 g/l and a particle size of 10 to 40 μm. Such a product is obtainable commercially under the name of Sipernat® 50 S (Evonik Industries, Germany).

Hydrophobic silicas are registered under CAS No. 68611-44-9 and are also commercially available, for example, under the trade name Sipernat® (Evonik Industries, Germany).

Hydrophobic silicas preferably used according to the invention have a methanol wettability of at least 40%, preferably at least 45%, particularly preferably at least 50%, particularly 40 to 65%, especially 50 to 60%.

They preferably also have a tamped density (unsieved; based on ISO 787-11) of 100 to 200 g/l, preferably 125 to 175 g/l.

The particle size of the hydrophobic silica (d50; laser diffraction; based on ISO 13320-1) is preferably 5 to 15 μm, particularly 8 to 12 μm.

Loss on drying of the hydrophobic silica (2 hours at 105° C.; based on ISO 787-2) is preferably at most 10%, particularly preferably at most 6%.

Ignition loss of the hydrophobic silica (2 hours at 1000° C.; based on ISO 3262-1) is preferably at most 10%, particularly preferably at most 6%.

The silicon dioxide content of the hydrophobic silica is preferably at least 95% by weight, particularly preferably at least 97% by weight (based on ISO 3262-19).

The carbon content of the hydrophobic silica is preferably at most 3.5% by weight, particularly at most 2% by weight (based on ISO 3262-19).

The pH of the hydrophobic silica (5% in a 1:1 mixture of water and methanol; based on ISO 787-9) is preferably from 7 to 10.5, particularly preferably from 7.5 to 9.

The methanol wettability is a measure of the hydrophobicity of the silica powder. To determine this value, a certain amount of silica powder is weighed into water. The silica powder remains here on the surface. The amount of methanol required for wetting the powder is then determined. “Methanol wettability” is here understood to mean the methanol content of a methanol-water mixture in % by volume in which 50% of the hydrophobic silica sediments.

Hydrophobic silicas which can be used in accordance with the invention are, for example, obtainable under the trade names Sipernat® D 10, Sipernat® D 15 and Sipernat® D 17 (Evonik Industries, Germany).

The silica is metered into the biomass or fermentation broth preferably in an amount such that a concentration of up to 8% by weight, in particular 0.1 to 8.0% by weight, preferably up to 6% by weight, in particular 0.1 to 6.0% by weight, particularly preferably 0.2 to 2.5% by weight, especially 0.5 to 2.5% by weight, in particular 0.5 to 1.5% by weight or 0.5 to 1% by weight, is established in the final dried product.

Prior to starting the actual drying, the fermentation broth preferably has a solids content of 10 to 50% by weight, and correspondingly a water content of 50 to 90% by weight. If required, the fermentation broth is adjusted to this water content prior to the actual drying.

“Solids content” in accordance with the invention is understood to mean the mass which remains on complete removal of the water. This dry mass also includes, in addition to suspended substances if applicable (such as the biomass), dissolved substances which only crystallize out or precipitate on drying. The solids content is in this respect complementary to the water or moisture content.

The composition comprising biomass used in the drying process is preferably the product of a cultivation process by fermentation and is also correspondingly referred to as fermentation broth. The fermentation broth to be used according to the invention preferably comprises further constituents of the fermentation medium in addition to the biomass to be dried. These components may take the form of, in particular, salts, antifoam agents and unreacted carbon source and/or nitrogen source. In the drying process, a product is preferably formed having a cell content of at least 60% by weight, preferably at least 65% by weight, particularly at least 70 or 80% by weight, where the further constituents present are the silica and optionally the further constituents of the fermentation medium mentioned above and also optionally components liberated partially from the cells. The further constituents of the fermentation broth may optionally be partially removed prior to drying the biomass, for example, by solid-liquid separation methods, such that a product is formed in the drying process that preferably comprises these further components of the fermentation broth, particularly salts, in an amount of at most 20% by weight, particularly at most 15, 10 or 5% by weight.

The cells present in the biomass are cells comprising an oxidation-sensitive material of value. These can particularly take the form of cells which already naturally produce materials of value, preferably lipids, in particular PUFAs (polyunsaturated fatty acids), but may also take the form of cells which have been made capable of producing lipids, in particular PUFAs, by means of suitable genetic engineering methods. In this context, the production may be autotrophic, mixotrophic or heterotrophic.

The biomass preferably comprises cells which produce lipids, in particular PUFAs, heterotrophically. The cells according to the invention preferably take the form of algae, fungi, particularly yeasts, or protists. The cells are especially preferably microbial algae or fungi.

Suitable cells of oil-producing yeasts are, in particular, strains of Yarrowia, Candida, Rhodotorula, Rhodosporidium, Cryptococcus, Trichosporon and Lipomyces.

The biomass according to the invention preferably comprises cells from the taxon Labyrinthulomycetes (Labyrinthulea, slime nets), in particular those from the family of Thraustochytriaceae. The family of the Thraustochytriaceae includes the genera Althomia, Aplanochytrium, Elnia, Japonochytrium, Schizochytrium, Thraustochytrium, Aurantiochytrium, Oblongichytrium and Ulkenia. The biomass particularly preferably comprises cells from the genera Thraustochytrium, Schizochytrium, Aurantiochytrium or Oblongichytrium, above all those from the genus Aurantiochytrium.

Within the genus Aurantiochytrium, the species Aurantiochytrium limacinum (previously also known as Schizochytrium limacinum) is preferred according to the invention. The strain Aurantiochytrium limacinum SR21 (IFO 32693) is very particularly preferably used according to the invention.

The oxidation-sensitive material of value is preferably an oxidation-sensitive lipid, particularly an unsaturated fatty acid, particularly preferably a polyunsaturated fatty acid (PUFA) or highly-unsaturated fatty acid (HUFA).

The cells present in the biomass are preferably distinguished by the fact that they contain at least 20% by weight, preferably at least 30% by weight, in particular at least 40% by weight, of material of value, preferably of lipids, especially preferably of PUFAs, in each case based on cell dry matter.

In a preferred embodiment, the majority of the lipids in this case is present in the form of triglycerides, with preferably at least 50% by weight, in particular at least 75% by weight and, in an especially preferred embodiment, at least 90% by weight of the lipids present in the cell being present in the form of triglycerides.

Furthermore, the lipids present in the cell preferably comprise polyunsaturated fatty acids (PUFAs), with preferably at least 10% by weight, in particular at least 20% by weight, especially preferably 20 to 60% by weight, in particular 20 to 40% by weight, of the fatty acids present in the cell being PUFAs.

According to the invention, polyunsaturated fatty acids (PUFAs) are understood to mean fatty acids having at least two, particularly at least three, C-C double bonds. According to the invention, highly-unsaturated fatty acids (HUFAs) are preferred among the PUFAs. According to the invention, HUFAs are understood to mean fatty acids having at least four C-C double bonds.

The PUFAs may be present in the cell in free form or in bound form. Examples of the presence in bound form are phospholipids and esters of the PUFAs, in particular monoacyl-, diacyl- and triacylglycerides. In a preferred embodiment, the majority of the PUFAs is present in the form of triglycerides, with preferably at least 50% by weight, in particular at least 75% by weight and, in an especially preferred embodiment, at least 90% by weight of the PUFAs present in the cell being present in the form of triglycerides.

Preferred PUFAs are omega-3 fatty acids and omega-6 fatty acids, with omega-3 fatty acids being especially preferred. Preferred omega-3 fatty acids here are the eicosapentaenoic acid (EPA, 20:5ω-3), particularly the (5Z,8Z,11Z,14Z,17Z)-eicosa-5,8,11,14,17-pentaenoic acid, and the docosahexaenoic acid (DHA, 22:6ω-3), particularly the (4Z,7Z,10Z,13Z,16Z,19Z)-docosa-4,7,10,13,16,19-hexaenoic acid, with the docosahexaenoic acid being especially preferred.

Processes for production of biomass, particularly that biomass which contains cells comprising the lipids, particularly PUFAs, particularly from the order Thraustochytriales, are described extensively in the prior art. As a rule, the production takes place by cells being cultured in a fermenter in the presence of a carbon source and of a nitrogen source. In this context, biomass densities of more than 100 grams per litre and production rates of more than 0.5 gram of lipid per litre per hour may be attained. The process is preferably carried out in what is known as a fed-batch process, i.e. the carbon and nitrogen sources are fed in incrementally during the fermentation. When the desired biomass has been obtained, lipid production may be induced by various measures, for example by limiting the nitrogen source, the carbon source or the oxygen content or combinations of these.

Preferably, the cells are fermented in a medium with low salinity, in particular so as to avoid corrosion. This can be achieved by employing chlorine-free sodium salts as the sodium source instead of sodium chloride, such as, for example, sodium sulphate, sodium carbonate, sodium hydrogen carbonate or soda ash. Preferably, chloride is employed in the fermentation in amounts of less than 3 g/l, in particular less than 500 mg/l, especially preferably less than 100 mg/l.

Suitable carbon sources are both alcoholic and non-alcoholic carbon sources. Examples of alcoholic carbon sources are methanol, ethanol and isopropanol. Examples of non-alcoholic carbon sources are fructose, glucose, sucrose, molasses, starch and corn syrup.

Suitable nitrogen sources are both inorganic and organic nitrogen sources. Examples of inorganic nitrogen sources are nitrates and ammonium salts, in particular ammonium sulphate and ammonium hydroxide. Examples of organic nitrogen sources are amino acids, in particular glutamate, and urea.

In addition, inorganic or organic phosphorus compounds and/or known growth-stimulating substances such as, for example, yeast extract or corn steep liquor, may also be added so as to have a positive effect on the fermentation.

The cells are preferably fermented at a pH of 5 to 11, in particular 6 to 10, and preferably at a temperature of at least 20° C., in particular 20 to 40° C., especially preferably at least 30° C. A typical fermentation process takes up to approximately 100 hours.

After the fermentation has ended, the biomass is harvested. After harvesting the biomass or even optionally shortly before harvesting the biomass, the cells are preferably pasteurized in order to kill the cells and to deactivate enzymes which might promote lipid degradation. The pasteurization is preferably effected by heating the biomass to a temperature of 50 to 121° C. for a period of 5 to 60 minutes.

Likewise, after harvesting the biomass or even optionally shortly before harvesting the biomass, antioxidants are preferably added in order to protect the material of value present in the biomass from oxidative degradation. Preferred antioxidants in this context are BHT, BHA, TBHA, ethoxyquin, beta-carotene, vitamin E and vitamin C. The antioxidant, if used, is preferably added in an amount of 0.01 to 2% by weight.

On completion of the fermentation, silica may optionally even already be added to the fermentation broth. This, however, is a less preferred embodiment. It has been found to be advantageous to add the silica only during the actual drying process or even only after the actual drying process.

Before the actual drying, a portion of the fermentation medium may now optionally already be separated from the biomass and the solid fraction can thus be increased. This may be carried out in particular by centrifugation, flotation, filtration, particularly ultrafiltration or microfiltration, decanting and/or solvent evaporation. In this case the solvent is preferably evaporated using a rotary evaporator, a thin film evaporator or a falling-film evaporator in a single stage or multistage process. Alternatively, reverse osmosis, for example, is also useful for concentrating the fermentation broth.

In this first optional but preferred step, the fermentation broth is preferably concentrated to a solids content of at least 10 or 15% by weight, preferably of at least 20 or 25% by weight, particularly 10 to 50 or 15 to 45% by weight, particularly preferably 15 to 40% by weight or 20 to 40% by weight.

This means that the biomass to be dried in a method according to the invention is preferably present in the form of a suspension having the solid fraction stated above, where the suspension is preferably a fermentation broth or concentrated fermentation broth.

After the optional concentration of the fermentation broth, the biomass is then dried in accordance with the invention, preferably by spray drying, particularly nozzle spray drying, spray granulation, fluidized bed granulation, particularly fluidized bed granulation, or in a drum dryer.

Alternatively, the biomass may also be subjected to the drying step directly after harvesting without prior concentration, particularly if the fermentation broth obtained already has a high solids content, preferably as stated above.

On drying the biomass, this is preferably dried to a residual moisture content of at most 10% by weight, particularly 0 to 10% by weight, particularly preferably at most 8% by weight, particularly 0.5 to 8% by weight, above all at most 6 or 5% by weight, particularly 0.5 to 6 or 0.5 to 5% by weight.

After the drying, preferably at least 50%, particularly at least 60 or 70%, especially at least 80 or 90% of the cells present in the biomass are in the intact state. The number of intact cells may be determined visually, for example, using a microscope, as the ratio of the number of intact cells relative to the total number of the cells.

In a particularly preferred embodiment of the invention, the biomass is dried in accordance with the invention in a fluidized bed granulation process or a nozzle spray drying process. For this purpose, the fermentation broth comprising biomass and also optionally the silica are preferably sprayed into the respective drying zone.

The drying gas is introduced from below into the fluidized bed granulation drying system. The majority of the moisture in the injected fermentation broth evaporates and the granulate formed is maintained suspended by the gas flow of the drying gas. In this state, the particles are separated from one another and in this manner are freely accessible to the spray droplets when further liquid is sprayed into the bed. Also in this state, the heat and mass transfer between the solid particles and the gas flow is intensive. Product particles of the desired size are continuously removed from the fluidized bed in a classifying offtake.

The fluidized bed or the bed of particles, which must be present at the beginning of the fluidized bed granulation drying process, preferably consists of a mixture of the silica particles and dried particles of the biomass used for drying, for example, from a batch of a previous run. It is, however, equally possible to use another material as fluidized bed for initiating the fluidized bed granulation drying process.

In addition, fine particles (<100 μm) of the dried biomass are preferably metered in during the fluidized bed granulation. This is preferably accomplished at a one-to-one ratio relative to the solid which passes into the drying zone with the fermentation broth. These fine particles may be generated from a simultaneous grinding of the finished product. Alternatively, these fine particles may also be produced in an upstream process step of the spray drying process.

In the nozzle spray drying process, the fermentation broth introduced is atomized in a defined droplet size and is dried with the drying air introduced in a continuous flow. Since the individual droplets are also separated from one another in this process, there is good heat and mass transfer and thus an efficient drying. Moreover, the particle size of the dried end product may be adjusted in a defined manner via setting the droplet size in the nozzle and thus a classification operation is not necessary.

In both advantageous drying processes, the silica is atomized in the drying zone in order to avoid the drying particles sticking to one another. The silica thereby functions as a so-called anti-caking agent, whereby the setting of a defined and controllable particle size becomes possible.

The drying gas is preferably passed over the biomass in both drying processes in cycle gas mode. “Cycle gas mode” means that the gas used for the drying is passed over the biomass in a circulating manner. The gas used in the drying process preferably has a temperature above the saturation temperature of the solvent to be evaporated. The gas used is preferably air, preferably air having a reduced oxygen content.

The gas conducted in cycle gas mode preferably has an oxygen content of less than 20% by weight, preferably less than 15% by weight, particularly from 5 to 13% by weight.

The gas is preferably generated by passing air over a burner and heating it in this manner. The oxygen content of the air is thereby reduced at the same time to less than 20% by weight, preferably to less than 15% by weight, particularly from 5 to 13% by weight. The gas is constantly readjusted in the same manner in order to generate a constant gas flow with reduced oxygen content.

In both methods, the biomass present in the fermentation broth is directly converted into a granulate. A particular advantage of these methods therefore consists in that biomass present in the fermentation broth can be dried in a single step to give a product of desired particle size and therefore only one method step is required from the fermentation broth containing the biomass to the finished product.

A further advantage of these methods consists in that they may be operated in continuous and static mode: fermentation broth containing biomass and silica may be continuously sprayed in and the finished product may be continuously discharged.

The fluidized bed in the fluidized bed granulation preferably has a temperature of 45 to 95° C., particularly 45 to 75° C., particularly preferably 50 to 60° C. The air is correspondingly heated strongly enough that a temperature of 45 to 95° C., particularly 45 to 75° C., particularly preferably 50 to 60° C. is reached in the fluidized bed.

The drying temperature in the spray nozzle tower can be set to 95° C. owing to the short residence times.

Particular preference is given to a method according to the invention for preparing a particulate biomass comprising an oxidation-sensitive material of value, starting from a fermentation broth, characterized in that the fermentation broth is subjected to a nozzle spray drying or a fluidized bed granulation drying process, in which silica is metered in simultaneously during the drying process such that a concentration of silica is achieved in the final product of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and where the biomass comprises cells from the taxon Labyrinthulomycetes, in particular those from the family of Thraustochytriaceae, preferably those from the genera Thraustochytrium, Schizochytrium or Aurantiochytrium, especially those from the genus Aurantiochytrium.

Very particular preference in this case is given to a method for preparing a particulate biomass starting from a fermentation broth, characterized in that the fermentation broth is subjected to a nozzle spray drying or a fluidized bed granulation drying process, in which a hydrophilic silica is metered in simultaneously during the drying process such that a concentration of hydrophilic silica is achieved in the final product of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and where the biomass comprises cells from the taxon Labyrinthulomycetes, in particular those from the family of Thraustochytriaceae, preferably those from the genera Thraustochytrium, Schizochytrium or Aurantiochytrium, especially those from the genus Aurantiochytrium, and where the hydrophilic silica preferably has a specific surface area (ISO 9277) of 130 to 600 m²/g, prefererably 160 to 550 m²/g, and has a dioctyl adipate absorption value of 1.5-4.0 ml/g, preferably 2.0-3.2 ml/g.

Very particular preference in this case is also given to a method for preparing a particulate biomass starting from a fermentation broth, characterized in that the fermentation broth is subjected to a nozzle spray drying or a fluidized bed granulation drying process, in which a hydrophobic silica is metered in simultaneously during the drying process such that a concentration of hydrophobic silica is achieved in the final product of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and where the biomass comprises cells from the taxon Labyrinthulomycetes, in particular those from the family of Thraustochytriaceae, preferably those from the genera Thraustochytrium, Schizochytrium or Aurantiochytrium, especially those from the genus Aurantiochytrium, and where the hydrophobic silica preferably has a methanol wettability of at least 40%, preferably at least 45%, particularly preferably at least 50%, particularly 40 to 65%, especially 50 to 60%.

Particular preference is also given to a method according to the invention for preparing a particulate biomass comprising oxidation-sensitive material of value starting from a fermentation broth, characterized in that the fermentation broth is subjected to a nozzle spray drying or a fluidized bed granulation drying process, in which silica is metered in in an additional method step after the drying such that a concentration of silica is achieved in the final product of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and where the biomass comprises cells from the taxon Labyrinthulomycetes, in particular those from the family of Thraustochytriaceae, preferably those from the genera Thraustochytrium, Schizochytrium or Aurantiochytrium, especially those from the genus Aurantiochytrium.

Very particular preference is given in this case to a method for preparing a particulate biomass starting from a fermentation broth, characterized in that the fermentation broth is subjected to a nozzle spray drying or a fluidized bed granulation drying process, in which hydrophilic silica is metered in in an additional method step after the drying such that a concentration of hydrophilic silica is achieved in the final product of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and where the biomass comprises cells from the taxon Labyrinthulomycetes, in particular those from the family of Thraustochytriaceae, preferably those from the genera Thraustochytrium, Schizochytrium or Aurantiochytrium, especially those from the genus Aurantiochytrium and where the hydrophilic silica preferably has a specific surface area (ISO 9277) of 130 to 600 m²/g, preferably 160 to 550 m²/g, and a dioctyl adipate absorption of 1.5-4.0 ml/g, preferably 2.0-3.2 ml/g.

Very particular preference is likewise given in this case to a method for preparing a particulate biomass starting from a fermentation broth, characterized in that the fermentation broth is subjected to a nozzle spray drying or a fluidized bed granulation drying process, in which hydrophobic silica is metered in in an additional method step after the drying such that a concentration of hydrophobic silica is achieved in the final product of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and where the biomass comprises cells from the taxon Labyrinthulomycetes, in particular those from the family of Thraustochytriaceae, preferably those from the genera Thraustochytrium, Schizochytrium or Aurantiochytrium, especially those from the genus

Aurantiochytrium and where the hydrophobic silica preferably has a methanol wettability of at least 40%, preferably at least 45%, particularly preferably at least 50%, in particular 40 to 65%, especially 50 to 60%.

However, other drying methods, such as drying in the fluidized bed and drum dryer and also spray drying using a rotating disc, have also been found to be very suitable for drying the fermentation broth.

The particles produced by the thermal drying have an excellent consistency and have very good bulk properties and flow characteristics due to their essentially round shape. The particles also have a low residual moisture content.

A free-flowing, fine-grained or coarse-grained product, preferably a granulate, is obtained by the drying process. A product having the desired particle size can optionally be obtained from the granulate obtained by sieving or dust separation.

Providing a free-flowing fine-grained powder was obtained, this can optionally be converted into a coarse-grained, free-flowing and largely dust-free product, which can be stored, by suitable compacting or granulating processes.

“Free-flowing” according to the invention is understood to mean a powder that can flow out unhindered from a series of glass efflux vessels having different size outflow openings, at least from the vessel having the 5 millimetre opening (Klein: Seifen, Öle, Fette, Wachse 94, 12 (1968)).

“Fine-grained” according to the invention is understood to mean a powder having a predominant fraction (>50%) of particle sizes of 20 to 100 micrometres in diameter.

“Coarse-grained” according to the invention is understood to mean a powder having a predominant fraction (>50%) of particle sizes of 100 to 2500 micrometres in diameter.

“Dust-free” according to the invention is understood to mean a powder that contains only low fractions (<10%, preferably <5%) of particle sizes below 100 micrometres.

Grain or particle size is preferably determined according to the invention by laser diffraction spectrometric methods. Possible methods are described in the text book

“Teilchengröβenmessung in der Laborpraxis” [Particle size measurement in the laboratory] by R. H. Müller and R. Schuhmann, Wissenschaftliche Verlagsgesellschaft Stuttgart (1996) and in the text book “Introduction to Particle Technology” by M. Rhodes, Wiley & Sons (1998). Inasmuch as various methods can be used, the first-cited usable method from the text book of R. H. Müller and R. Schuhmann for the measuring of particle size is preferably used.

The products obtained by the drying process according to the invention preferably have a fraction of at least 80% by weight, particularly at least 90% by weight, particularly preferably at least 95% by weight, of particles having a particle size of 100 to 3500 micrometres, preferably 100 to 3000 micrometres, above all 100 to 2500 micrometres.

The products of a fluidized bed granulation process obtained according to the invention preferably have in this case a fraction of at least 80% by weight, particularly at least 90% by weight, particularly preferably at least 95% by weight, of particles having a particle size of 200 to 3500 micrometres, preferably 300 to 3000 micrometres, above all 500 to 2500 micrometres. The products of a nozzle spray drying process obtained according to the invention preferably have in contrast a fraction of at least 80% by weight, particularly at least 90% by weight, particularly preferably at least 95% by weight, of particles having a particle size of 100 to 500 micrometres, preferably 100 to 400 micrometres, above all 100 to 300 micrometres.

Owing to the preparation process, preferably at least 50 or 60% by weight, particularly at least 70 or 80% by weight, particularly preferably at least 90 or 95% by weight, above all essentially all particles are formed essentially spherical in shape. Especially the formation of essentially spherical particles accounts for the excellent bulk properties and flow characteristics of the product according to the invention.

“Formed essentially spherical in shape” is understood to mean, in accordance with the invention, that the diameter of a particle is essentially uniform in all spatial directions. “Essentially uniform” is understood to mean here that the variance of the diameter of a particle in any two spatial directions is at most 20%, preferably at most 15%, particularly at most 10%, particularly preferably at most 5%.

The fraction of dust, i.e. particle having a particle size of less than 100 micrometres, is preferably at most 10% by weight, particularly at most 8% by weight, particularly preferably at most 5% by weight.

The bulk density of the product according to the invention is preferably from 400 to 800 kg/m³, particularly preferably from 450 to 700 kg/m³.

The present invention therefore also relates to a particulate free-flowing biomass which can be obtained by a method according to the invention.

The present invention further relates also to a particulate free-flowing biomass, characterized in that said particulate biomass comprises silica in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight.

The present invention preferentially relates in this case to a particulate free-flowing biomass, characterized in that said particulate biomass comprises hydrophilic silica in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight.

The hydrophilic silica present in the particulate biomass preferably has in this case the properties mentioned above, i.e. in particular a specific surface area of 130 to 600 m²/g, preferably 160 to 550 m²/g, and a dioctyl adipate absorption value of 1.5-4.0 ml/g, preferably 2.0-3.2 ml/g.

The present invention further preferentially relates in this case to a particulate free-flowing biomass, characterized in that said particulate biomass comprises hydrophobic silica in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight.

The hydrophobic silica present in the particulate biomass preferably also has in this case the properties mentioned above, i.e. in particular a methanol wettability of at least 40%, preferably at least 45%, particularly preferably at least 50%, particularly 40 to 65%, especially 50 to 60%.

Furthermore, the particulate biomass according to the invention preferably has at least one of the other properties mentioned above, particularly with respect to particle size and particle distribution and also preferably with respect to the particle shape.

Thus the particulate biomass is preferably characterized in that at least 80% by weight, particularly at least 90% by weight, preferably at least 95% by weight, of the particles have a particle size of 100 to 3500 micrometres, preferably 100 to 2500 micrometres and the particulate biomass is preferably free-flowing and low in dust.

In addition, said biomass is preferably characterized in that at least 50% by weight, particularly at least 70% by weight, preferably at least 90% by weight, of the particles—in the context of the definitions stated above—are formed essentially spherical in shape.

In terms of the preferred nature of the biomass or of the cells present in the biomass and also in terms of the material of value preferably present, reference is made to that previously discussed. The oxidation-sensitive material of value is particularly preferably an omega-3 fatty acid or omega-6 fatty acid. The particulate biomass preferably comprises cells from the taxon Labyrinthulomycetes, in particular those from the family Thraustochytriaceae, particularly preferably from the genera Thraustochytrium, Schizochytrium or Aurantiochytrium, especially those from the genus Aurantiochytrium.

In this case, the present invention particularly preferably relates to a particulate free-flowing biomass comprising silica, preferably hydrophilic and/or hydrophobic silica, in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and also comprising cells from the taxon Labyrinthulomycetes, in particular those from the family Thraustochytriaceae, preferably those from the genera Thraustochytrium, Schizochytrium or Aurantiochytrium, especially those from the genus Aurantiochytrium, wherein at least 80% by weight, particularly at least 90% by weight, preferably at least 95% by weight, of the particles present have a particle size of 100 to 3500 micrometres, preferably 100 to 3000 micrometres, especially 100 to 2500 micrometres, and wherein—according to the definition above—preferably at least 50 or 60% by weight, particularly at least 70 or 80% by weight, particularly preferably at least 90 or 95% by weight, above all essentially all particles are formed essentially spherical in shape.

Very particular preference is given in this case to a particulate free-flowing biomass comprising silica, preferably hydrophilic and/or hydrophobic silica, in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and also comprising cells from the taxon Labyrinthulomycetes, in particular those from the family Thraustochytriaceae, preferably those from the genera Thraustochytrium, Schizochytrium or Aurantiochytrium, especially those from the genus

Aurantiochytrium, wherein at least 80% by weight, particularly at least 90% by weight, preferably at least 95% by weight, of the particles present have a particle size of 200 to 3500 micrometres, preferably 300 to 3000 micrometres, especially 500 to 2500 micrometres, and wherein—according to the definition above—preferably at least 50 or 60% by weight, particularly at least 70 or 80% by weight, particularly preferably at least 90 or 95% by weight, above all essentially all particles are formed essentially spherical in shape.

Very particular preference is also given in this case to a particulate free-flowing biomass comprising silica, preferably hydrophilic and/or hydrophobic silica, in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and also comprising cells from the taxon Labyrinthulomycetes, in particular those from the family Thraustochytriaceae, preferably those from the genera Thraustochytrium, Schizochytrium or Aurantiochytrium, especially those from the genus Aurantiochytrium, wherein at least 80% by weight, particularly at least 90% by weight, preferably at least 95% by weight, of the particles present have a particle size of 100 to 500 micrometres, preferably 100 to 400 micrometres, especially 100 to 300 micrometres, and wherein—according to the definition above—preferably at least 50 or 60% by weight, particularly at least 70 or 80% by weight, particularly preferably at least 90 or 95% by weight, above all essentially all particles are formed essentially spherical in shape.

In this case, the present invention particularly preferably relates in particular to a particulate free-flowing biomass comprising hydrophilic silica in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and also comprising cells from the taxon Labyrinthulomycetes, in particular those from the family Thraustochytriaceae, preferably those from the genera Thraustochytrium, Schizochytrium or Aurantiochytrium, especially those from the genus Aurantiochytrium, wherein at least 80% by weight, particularly at least 90% by weight, preferably at least 95% by weight, of the particles present have a particle size of 100 to 3500 micrometres, preferably 100 to 3000 micrometres, especially 100 to 2500 micrometres, and wherein—according to the definition above—preferably at least 50 or 60% by weight, particularly at least 70 or 80% by weight, particularly preferably at least 90 or 95% by weight, above all essentially all particles are formed essentially spherical in shape.

Very particular preference is given in this case to a particulate free-flowing biomass comprising hydrophilic silica in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and also comprising cells from the taxon Labyrinthulomycetes, in particular those from the family Thraustochytriaceae, preferably those from the genera Thraustochytrium, Schizochytrium or Aurantiochytrium, especially those from the genus Aurantiochytrium, wherein at least 80% by weight, particularly at least 90% by weight, preferably at least 95% by weight, of the particles present have a particle size of 200 to 3500 micrometres, preferably 300 to 3000 micrometres, especially 500 to 2500 micrometres, and wherein—according to the definition above—preferably at least 50 or 60% by weight, particularly at least 70 or 80% by weight, particularly preferably at least 90 or 95% by weight, above all essentially all particles are formed essentially spherical in shape.

Very particular preference is also given in this case to a particulate free-flowing biomass comprising hydrophilic silica in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and also comprising cells from the taxon Labyrinthulomycetes, in particular those from the family Thraustochytriaceae, preferably those from the genera Thraustochytrium, Schizochytrium or Aurantiochytrium, especially those from the genus Aurantiochytrium, wherein at least 80% by weight, particularly at least 90% by weight, preferably at least 95% by weight, of the particles present have a particle size of 100 to 500 micrometres, preferably 100 to 400 micrometres, especially 100 to 300 micrometres, and wherein—according to the definition above—preferably at least 50 or 60% by weight, particularly at least 70 or 80% by weight, particularly preferably at least 90 or 95% by weight, above all essentially all particles are formed essentially spherical in shape.

Particularly in this case, the present invention particularly preferably also relates to a particulate free-flowing biomass comprising hydrophobic silica in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and also comprising cells from the taxon Labyrinthulomycetes, in particular those from the family Thraustochytriaceae, preferably those from the genera Thraustochytrium, Schizochytrium or Aurantiochytrium, especially those from the genus Aurantiochytrium, wherein at least 80% by weight, particularly at least 90% by weight, preferably at least 95% by weight, of the particles present have a particle size of 100 to 3500 micrometres, preferably 100 to 3000 micrometres, especially 100 to 2500 micrometres, and wherein—according to the definition above—preferably at least 50 or 60% by weight, particularly at least 70 or 80% by weight, particularly preferably at least 90 or 95% by weight, above all essentially all particles are formed essentially spherical in shape.

Very particular preference is given in this case to a particulate free-flowing biomass comprising hydrophobic silica in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and also cells from the taxon Labyrinthulomycetes, in particular those from the family Thraustochytriaceae, preferably those from the genera Thraustochytrium, Schizochytrium or Aurantiochytrium, especially those from the genus Aurantiochytrium, wherein at least 80% by weight, particularly at least 90% by weight, preferably at least 95% by weight, of the particles present have a particle size of 200 to 3500 micrometres, preferably 300 to 3000 micrometres, especially 500 to 2500 micrometres, and wherein—according to the definition above—preferably at least 50 or 60% by weight, particularly at least 70 or 80% by weight, particularly preferably at least 90 or 95% by weight, above all essentially all particles are formed essentially spherical in shape.

Very particular preference is also given in this case to a particulate free-flowing biomass comprising hydrophobic silica in an amount of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight, and also comprising cells from the taxon Labyrinthulomycetes, in particular those from the family Thraustochytriaceae, preferably those from the genera Thraustochytrium, Schizochytrium or Aurantiochytrium, especially those from the genus Aurantiochytrium, wherein at least 80% by weight, particularly at least 90% by weight, preferably at least 95% by weight, of the particles present have a particle size of 100 to 500 micrometres, preferably 100 to 400 micrometres, especially 100 to 300 micrometres, and wherein—according to the definition above—preferably at least 50 or 60% by weight, particularly at least 70 or 80% by weight, particularly preferably at least 90 or 95% by weight, above all essentially all particles are formed essentially spherical in shape.

The dried particulate biomass obtained according to the invention may be used in various ways. After drying of the biomass in accordance with the invention, the dried biomass is preferably stored or packed. The biomass can subsequently be used on site, for example, to manufacture foodstuff or feedstuff or to isolate the material of value from the biomass.

A feedstuff or foodstuff comprising a particulate biomass according to the invention is therefore a further object of the present invention.

A further object of the present invention, therefore, is also a method for isolating the material of value from a particulate biomass according to the invention.

In order to increase the bioavailability of the feedstuff or foodstuff to be produced and/or to facilitate the isolation of the material of value present in the biomass, the particulate biomass—directly before preparing the feedstuff or foodstuff or directly before isolating the material of value—is preferably subjected to a cell disruption process.

A cell suspension is preferably prepared, based on the dried biomass, before carrying out the cell disruption process. For this purpose, the dried biomass is mixed with water or an aqueous solution in order to prepare a cell suspension having a moisture content of preferably at least 30% by weight, particularly 30 to 90% by weight, particularly preferably 40 to 80% by weight, above all 50 to 75% by weight.

The cells may be subsequently disrupted using the cell disruption methods known to those skilled in the art, such as by using a screw extruder, a beater mill, an air-nozzle mill or by applying an elevated pressure, for example by what is known as the French Press method. Alternatively or additionally, the cells may be disrupted by using cell wall digesting enzymes.

The cell disruption is preferably carried out in accordance with the invention by using a rotor-stator system. The rotor-stator system is based on a stationary part, referred to as the stator, and a rotating part, the rotor. The rotor typically has a circumferential speed of at least 5 m/s, for example 10 to 30 m/s, and the gap width between rotor and stator may be for example 0.1-0.5 mm. To disrupt the cells, the cell suspension is placed into the gap between stator and rotor. The cells are subjected to a shear stress in this gap and, additionally, turbulences are caused. These two factors bring about the disruption of the cells.

In a preferred embodiment, the suspension is prepared in the rotor-stator system using a solid mixing attachment. A solid mixing attachment in this context is understood to mean a device which allows the separate introduction of solid on the one hand and water or aqueous solution on the other hand into the rotor-stator system. The suspension is therefore prepared only during the cell disruption or immediately before the cell disruption by mixing in the solid mixing attachment. It has been found that, using such a solid mixing attachment, suspensions with very high solids contents may be subjected to the cell disruption process, which is particularly advantageous with respect to the subsequent processing. Suspensions, used when a solid mixing attachment is used in the rotor-stator system, preferably have a solids content of 20-50% by weight, particularly preferably of 30-50% by weight.

If an aqueous solution is used to prepare the cell suspension, it may comprise in particular other foodstuff components—such as vitamins or salts.

According to the invention, the energy input into the cells, particularly when using a rotor-stator system, is preferably at most 50 kWh per tonne of suspension, particularly at most 40, 35 or 30 kWh per tonne of suspension, particularly preferably at most 25, 20 or 15 kWh per tonne of suspension. Preferred ranges in this context are energy inputs of 0.1-50 kWh per tonne of suspension, particularly 0.3-45 kWh, particularly preferably 0.5-40 kWh, particularly 0.8-35 kWh, above all 1-30 kWh, particularly 1.5-25 kWh, 2-20 kWh or 3-15 kWh, in each case per tonne of suspension.

The “cell disruption rate” of the process according to the invention is preferably at least 50%, particularly preferably at least 60, 70 or 80%, above all at least 85, 90 or 95%. The “cell disruption rate” is understood to mean the number of the disrupted cells, after the end of the cell disruption process, as a ratio to the total number of cells. The cell disruption rate may be determined visually, for example, using a microscope, as the ratio of the number of disrupted cells relative to the total number of cells.

To stabilize the materials of value, particularly lipids, against oxidative degradation, the cell suspension used for the cell disruption may additionally comprise antioxidants. Preferred antioxidants in this context are BHT, BHA, TBHA, ethoxyquin, beta-carotene, vitamin E and vitamin C. The antioxidant, if used, is preferably present in an amount of 0.01 to 2% by weight. In a preferred embodiment, the antioxidants in this case are already added to the fermentation medium after completion of the fermentation.

The material of value may be isolated from the biomass both proceeding from the intact dried biomass and proceeding from the disrupted biomass.

The material of value may be isolated from the disrupted biomass, for example, by a simple mechanical removal of the cell debris, for example by decanting, filtration or centrifugation.

The material of value can otherwise be isolated both from the intact and also from the disrupted biomass, for example, by solvent extraction. Once the material of value has been separated off, accordingly, the solvent can be removed once again, for example by applying reduced pressure. Alternatively, the material of value can be isolated, for example, by supercritical fluid extraction.

The solvents used may be the solvents known to those skilled in the art, for example, chloroform, ether, hexane, methylene chloride or methanol. The oil may also be separated, for example, by using a different oil for extracting the oil according to the invention.

The oil may subsequently be subjected to chemical or physical refining. Refining may comprise degumming, bleaching, filtering, deodorizing and/or polishing of the crude oil. Individual oil components may then optionally be isolated.

Both the intact and the disrupted biomass and also the materials of value isolated from the biomass may be used to prepare a foodstuff or feedstuff, in which the biomass or the material of value are preferably mixed with other foodstuff or feedstuff ingredients and are subsequently processed to form the foodstuff or feedstuff.

The mixture of biomass and other foodstuff or feedstuff ingredients are processed in a preferred embodiment by an extrusion process, in order to obtain portions of foodstuff or feedstuff ready for sale. Alternatively, a pelleting method may also be used, for example.

A screw or twin-screw extruder is preferably employed in the extrusion process. The extrusion process is preferably carried out at a temperature of 80-220° C., particularly 100-190° C., a pressure of 10-40 Bar, and a shaft rotational speed of 100-1000 rpm, particularly 300-700 rpm. The residence time of the mixture introduced is preferably 5-30 seconds, in particular 10-20 seconds.

In a mode of the extrusion process which is preferred in accordance with the invention, the process comprises a compacting step and a compression step.

It is preferred to intimately mix the components with each other before carrying out the extrusion process. This is preferably carried out in a drum equipped with vanes. In this mixing step, a preferred embodiment includes an injection of steam, in particular so as to bring about the swelling of the starch which is preferably present.

Before being mixed with the disrupted cells, the further foodstuff or feedstuff ingredients are preferably comminuted—if required—so as to ensure that a homogeneous mixture is obtained in the mixing step. The comminuting of the further foodstuff or feedstuff ingredients may be carried out, for example, using a hammer mill.

A process which is preferred in accordance with the invention for preparing foodstuff or feedstuff therefore comprises the following steps:
a) preparing a biomass by fermenting fungi or microalgae, which produce a material of value, preferably a lipid, particularly preferably omega-3 fatty acids;
b) thermal drying under mild conditions of a mixture of biomass obtained and silica, particularly hydrophilic or hydrophobic silica, preferably by nozzle spray drying or fluidized bed granulation, to give a particulate composition, wherein the silica is preferably added in an amount such that a final concentration of silica in the final product is established of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight and where the hydrophilic silica preferably has a specific surface area (ISO 9277) of 130 to 600 m²/g, particularly 160 to 550 m²/g, and has a dioctyl adipate absorption value of 1.5-4.0 ml/g, preferably 2.0-3.2 ml/g, and the hydrophobic silica preferably has a methanol wettability of at least 40%, preferably at least 45%, particularly preferably at least 50%, particularly 40 to 65%, especially 50 to 60%;
c) mixing the biomass and/or materials of value isolated therefrom, optionally after carrying out a prior cell disruption process, with other foodstuff or feedstuff ingredients;
d) preparing the final product by a compacting or extrusion process.

A very particularly preferred method in accordance with the invention for preparing a foodstuff or feedstuff comprises in this case the following steps:
a) preparing a biomass by fermenting cells from the taxon Labyrinthulomycetes, in particular those from the family Thraustochytriaceae, preferably those from the genera Thraustochytrium, Schizochytrium or Aurantiochytrium, especially those from the genus Aurantiochytrium;
b) thermal drying under mild conditions of a mixture of biomass obtained and silica, particularly hydrophilic or hydrophobic silica, preferably by nozzle spray drying or fluidized bed granulation, to give a particulate composition having a moisture content of less than 15% by weight, preferably less than 10% by weight, particularly 1-9% by weight, particularly preferably less than 5% by weight, particularly 1-4.5% by weight, wherein the silica is preferably added in an amount such that a final concentration of silica in the final product is established of 1 to 8% by weight, preferably 2 to 6% by weight and where the silica preferably has a specific surface area (ISO 9277) of 130 to 600 m²/g, particularly 160 to 550 m²/g, and has a dioctyl adipate absorption value of 1.5-4.0 ml/g, preferably 2.0-3.2 ml/g, and the hydrophobic silica preferably has a methanol wettability of at least 40%, preferably at least 45%, particularly preferably at least 50%, particularly 40 to 65%, especially 50 to 60%;
c) disrupting the cells, preferably employing an energy input of no more than 50 kWh per tonne of suspension, preferably of 0.1-50 kWh, particularly 0.3-45 kWh, particularly preferably 0.5-40 kWh, particularly 0.8-35 kWh, above all 1-30 kWh, particularly 1.5-25 kWh, 2-20 kWh or 3-15 kWh, in each case per tonne of suspension, preferably using a rotor-stator system;
d) mixing the disrupted cells and/or materials of value isolated therefrom with other foodstuff or feedstuff ingredients;
e) preparing the final product by a compacting or extrusion process.

A further preferred method in accordance with the invention for preparing a foodstuff or feedstuff comprises the following steps:
a) preparing a biomass by fermenting cells from the taxon Labyrinthulomycetes, in particular those from the family Thraustochytriaceae, preferably those from the genera Thraustochytrium, Schizochytrium or Aurantiochytrium, especially those from the genus Aurantiochytrium;
b) thermal drying under mild conditions of the biomass obtained, preferably by nozzle spray drying or fluidized bed granulation, to give a particulate composition,
c) mixing of the dried biomass with silica, preferably a hydrophilic or hydrophobic silica, wherein the silica is added preferably in an amount such that a final concentration of silica in the final product is achieved of up to 8% by weight, in particular 0.1 to 8.0% by weight, preferably up to 6% by weight, in particular 0.2 to 6.0% by weight, especially 0.5 to 2.5% by weight, in particular 0.5 to 1.5% by weight or 0.5 to 1% by weight and where the hydrophilic silica preferably has a specific surface area (ISO 9277) of 130 to 600 m²/g, in particular 160 to 550 m²/g, and a dioctyl adipate absorption of 1.5-4.0 ml/g, preferably 2.0-3.2 ml/g and the hydrophobic silica preferably has a methanol wettability of at least 40%, preferably at least 45%, particularly preferably at least 50%, in particular 40 to 65%, especially 50 to 60%;
c) mixing of the biomass and/or materials of value isolated therefrom, optionally after first carrying out a cell disruption process, with other foodstuff or feedstuff ingredients;
d) preparing the final product by a compacting or extrusion process.

Preferred methods for preparing a foodstuff or feedstuff according to the invention are preferably characterized in that the energy input to the biomass is no higher than 50 kWh per tonne of suspension in any method step. The energy input to the biomass is preferably at most 40 or 35 kWh, particularly at most 30 or 25 kWh, particularly preferably 20 or 15 kWh, in each case per tonne of suspension. This additionally ensures that the material of value present is adversely affected as little as possible.

The disrupted cells preferably account for 0.5-20% by weight, particularly 1-10% by weight, preferably 2-8% by weight of the foodstuff or feedstuff or of the composition used for preparing the foodstuff or feedstuff.

The foodstuff or feedstuff is preferably a product for use in aquaculture or a foodstuff or feedstuff for use in poultry production, pig production or cattle production. The feedstuff may also take the form of a feedstuff which is employed for growing small organism which may be employed as feedstuff in aquaculture. The small organism may take the form of, for example, nematodes, crustaceans or rotifers. The feedstuff is preferably present in the form of flakes, spheres or tablets. A feedstuff obtainable by extrusion has a moisture content of preferably less than 5% by weight, especially preferably 0.2 to 4% by weight.

The other foodstuff or feedstuff ingredients are preferably selected from protein-containing, carbohydrate-containing, nucleic-acid-containing and lipid-soluble components and, if appropriate, further fat-containing components and furthermore from among other additives such as minerals, vitamins, pigments and amino acids. Besides, structurants may also be present, besides nutrients, for example so as to improve the texture or the appearance of the feedstuff. Furthermore, it is also possible to employ, for example, binders so as to influence the consistency of the feedstuff. A component which is preferably employed and which constitutes both a nutrient and a structurant is starch.

The following examples may be employed as a protein-containing component which additionally contains fats: fish meal, krill meal, bivalve meal, squid meal or shrimp shells. As an alternative, fish oil may also be employed as a fat-containing component. A vegetable oil may also be employed as a fat-containing component, in particular oil from soybeans, rapeseed, sunflower kernels and flaxseeds. An example of a carbohydrate-containing component which may be employed is wheat meal, sunflower meal, soya meal or cereal gluten.

The total oil content in the feedstuff—including the oil from the oil-containing cells—amounts preferably to 15-50% by weight.

The feedstuff for use in aquaculture is preferably used for breeding finfish and crustaceans which are preferably intended for human nutrition. These include, in particular, carp, tilapia, catfish, tuna, salmon, trout, barramundi, bream, perch, cod, shrimps, lobster, crabs, prawns and crayfish. It is especially preferably a feedstuff for salmon farming. Preferred types of salmon in this context are the Atlantic salmon, red salmon, masu salmon, king salmon, keta salmon, coho salmon, Danube salmon, Pacific salmon and pink salmon.

Alternatively, it may also be a feedstuff intended for farming fish which are subsequently processed to give fish meal or fish oil. These fish are preferably herring, pollack, menhaden, anchovies, caplin or cod. The fish meal or fish oil thus obtained, in turn, can be used in aquaculture for farming edible fish or crustaceans.

Aquaculture may take place in ponds, tanks, basins or else in segregated areas in the sea or in lakes, in particular in this case in cages or net pens. Aquaculture may be used for farming the finished edible fish, but also may be used for farming fry which are subsequently released so as to restock the wild fish stocks.

In salmon farming, the fish are preferably first grown into smolts in freshwater tanks or artificial watercourses and then grown on in cages or net pens which float in the sea and which are preferably anchored in bays or fjords.

Accordingly, a further object of the present invention is also a method for farming animals, in particular finfish or crustaceans, preferably salmon, in which a feedstuff according to the invention is employed. A further object of the present invention is additionally an animal, in particular a finfish or shellfish, which is obtainable by such a method according to the invention.

The present invention further provides methods for obtaining an oxidation-sensitive material of value from a biomass comprising a drying step in accordance with the invention.

### WORKING EXAMPLES

### Example 1

### Preparation of a DHA-Containing Particulate Free-Flowing Biomass Comprising Hydrophilic Silica

The Schizochytrium limacinum SR21 strain was used to produce DHA. This is deposited at the NIBH under FERM BP-5034 and at the IFO under IFO 32693. The S. limacinum SR21 strain was originally isolated from seawater (Nakahara et al. 1996, JAOCS, 73 (10); Honda Mycol. Res. 1998).

The strain was fermented in a medium which contained 50% synthetic seawater (Sigma Aldrich) and contained the further following components: 60 g/l glucose, 0.7 g/l corn steep liquor (Sigma Aldrich), 2 g/l (NH₄)₂SO₄ and 3 g/l KH₂PO₄.

The fermentation was conducted for 60 hours at 28° C., a pH of 4.0, an aeration rate of 0.5 vvm and a stirring speed of 200 rpm. At the end of the fermentation, an antioxidant was added to the fermentation broth and the fermentation broth subsequently heated to 60° C. for at least 20 minutes.

Subsequently, a two-stage drying of the biomass was carried out: firstly the fermentation broth was concentrated to a dry mass of approximately 20% by weight by evaporation. Spray-drying of the concentrated fermentation broth was then carried out using a Production Minor™ Spray Dryer (GEA NIRO) at an inlet temperature of the drying air of 340° C. In several comparative experiments, during the spray-drying hydrophilic silica (Sipernat® 22S, Evonik, Germany) in dry form was metered in simultaneously by means of a second nozzle in an amount such that a concentration of hydrophilic silica in the final product was established of 0.5, 1.0 or 1.5% by weight. By means of spray-drying, a free-flowing powder with a dry mass of more than 95% by weight was thus obtained by addition of a relatively low amount of additive.

In the comparative experiment without addition of the hydrophilic silica, no free-flowing powder was obtained.

### Example 2

### Preparation of a DHA-Containing Particulate Free-Flowing Biomass Comprising Hydrophobic Silica

The Schizochytrium limacinum SR21 strain was used to produce DHA. This is deposited at the NIBH under FERM BP-5034 and at the IFO under IFO 32693. The S. limacinum SR21 strain was originally isolated from seawater (Nakahara et al. 1996, JAOCS, 73 (10); Honda Mycol. Res. 1998).

The strain was fermented in a medium which contained 50% synthetic seawater (Sigma Aldrich) and contained the further following components: 60 g/l glucose, 0.7 g/l corn steep liquor (Sigma Aldrich), 2 g/l (NH₄)₂SO₄ and 3 g/l KH₂PO₄.

The fermentation was conducted for 60 hours at 28° C., a pH of 4.0, an aeration rate of 0.5 vvm and a stirring speed of 200 rpm. At the end of the fermentation, an antioxidant was added to the fermentation broth and the fermentation broth subsequently heated to 60° C. for at least 20 minutes.

Subsequently, a two-stage drying of the biomass was carried out: firstly the fermentation broth was concentrated to a dry mass of approximately 20% by weight by evaporation. Spray-drying of the concentrated fermentation broth was then carried out using a Production Minor™ Spray Dryer (GEA NIRO) at an inlet temperature of the drying air of 340° C. In several comparative experiments, during the spray-drying hydrophobic silica (Sipernat® D10, Evonik, Germany) in dry form was metered in simultaneously by means of a second nozzle in an amount such that a concentration of hydrophobic silica in the final product was established of 0.5, 1.0 or 1.5% by weight. By means of spray-drying, a free-flowing powder with a dry mass of more than 95% by weight was thus obtained by addition of a relatively low amount of additive.

Without addition of the hydrophobic silica, no free-flowing powder was obtained.

### Example 3

### Preparation of a DHA-Containing Particulate Free-Flowing Biomass Comprising Hydrophilic Silica

The Schizochytrium limacinum SR21 strain was used to produce DHA. This is deposited at the NIBH under FERM BP-5034 and at the IFO under IFO 32693. The S. limacinum SR21 strain was originally isolated from seawater (Nakahara et al. 1996, JAOCS, 73 (10); Honda Mycol. Res. 1998).

The strain was fermented in a medium which contained 50% synthetic seawater (Sigma Aldrich) and contained the further following components: 60 g/l glucose, 0.7 g/l corn steep liquor (Sigma Aldrich), 2 g/l (NH₄)₂SO₄ and 3 g/l KH₂PO₄.

The fermentation was conducted for 60 hours at 28° C., a pH of 4.0, an aeration rate of 0.5 vvm and a stirring speed of 200 rpm. At the end of the fermentation, an antioxidant was added to the fermentation broth and the fermentation broth subsequently heated to 60° C. for at least 20 minutes.

Subsequently, a two-stage drying of the biomass was carried out: firstly the fermentation broth was concentrated to a dry mass of approximately 20% by weight by evaporation. Spray-drying of the concentrated fermentation broth was then carried out using a Production Minor™ Spray Dryer (GEA NIRO) at an inlet temperature of the drying air of 340° C. By means of spray-drying, a non-free-flowing powder with a dry mass of more than 95% by weight was thus obtained.

In several comparative experiments, the resulting powder was then mixed with hydrophilic silica (Sipernat® 22S) using a continuous mixer (Gericke Kontimischer GCM, Gericke, Germany) in an amount such that a concentration of hydrophilic silica in the final product was established of 0.5, 1.0 or 1.5% by weight. In this manner, the dried biomass could be converted into a free-flowing form.

### Example 4

### Preparation of a DHA-Containing Particulate Free-Flowing Biomass Comprising Hydrophobic Silica

The Schizochytrium limacinum SR21 strain was used to produce DHA. This is deposited at the NIBH under FERM BP-5034 and at the IFO under IFO 32693. The S. limacinum SR21 strain was originally isolated from seawater (Nakahara et al. 1996, JAOCS, 73 (10); Honda Mycol. Res. 1998).

The strain was fermented in a medium which contained 50% synthetic seawater (Sigma Aldrich) and contained the further following components: 60 g/l glucose, 0.7 g/l corn steep liquor (Sigma Aldrich), 2 g/l (NH₄)₂SO₄ and 3 g/l KH₂PO₄.

The fermentation was conducted for 60 hours at 28° C., a pH of 4.0, an aeration rate of 0.5 vvm and a stirring speed of 200 rpm. At the end of the fermentation, an antioxidant was added to the fermentation broth and the fermentation broth subsequently heated to 60° C. for at least 20 minutes.

Subsequently, a two-stage drying of the biomass was carried out: firstly the fermentation broth was concentrated to a dry mass of approximately 20% by weight by evaporation. Spray-drying of the concentrated fermentation broth was then carried out using a Production MinorTM Spray Dryer (GEA NIRO) at an inlet temperature of the drying air of 340° C. By means of spray-drying, a non-free-flowing powder with a dry mass of more than 95% by weight was thus obtained.

In several comparative experiments, the resulting powder was then mixed with hydrophobic silica (Sipernat® D10, Evonik, Germany) using a continuous mixer (Gericke Kontimischer GCM, Gericke, Germany) in an amount such that a concentration of hydrophobic silica in the final product was established of 0.5, 1.0 or 1.5% by weight. In this manner, the dried biomass could be converted into a free-flowing form.

1-15. (canceled)

16. A method for preparing a particulate free-flowing biomass comprising an oxidation-sensitive material of value, wherein said method comprises:
a) obtaining a fermentation broth comprising biomass;
b) optionally concentrating said fermentation broth to produce a concentrated broth;
c) drying either said fermentation broth or said concentrated broth;
d) adjusting the amount of silica in said fermentation broth or said concentrated broth either before or after the drying of step c) so that the concentration of silica in said particulate free-flowing biomass is 0.1-8% by weight.

17. The method of claim 16, wherein the silica is a hydrophilic silica.

18. The method of claim 17, wherein the hydrophilic silica has a specific surface area of 150 to 600 m²/g and a dioctyl adipate absorption value of 2-3.5 ml/g.

19. The method of claim 16, wherein the silica is a hydrophobic silica.

20. The method of claim 19, wherein the hydrophobic silica has a methanol wettability of at least 40%.

21. The method of claim 16, wherein the oxidation-sensitive material of value is an unsaturated fatty acid.

22. The method of claim 16, wherein the silica is adjusted so that the concentration of silica in the particulate biomass is 0.2 to 6% by weight.

23. The method of claim 16, wherein the biomass comprises cells from the taxon Labyrinthulomycetes.

24. The method of claim 16, wherein the fermentation broth has a solids content of 10 to 50% by weight, and is converted to the particulate biomass by drying.

25. The method of claim 16, wherein biomass is dried by a thermal process and silica is added during the drying process.

26. The method of claim 16, wherein:
a) the oxidation-sensitive material of value is an omega-3 fatty acid or an omega-6 fatty acid;
b) the silica is adjusted so that the concentration of silica in the particulate biomass is 0.2 to 6% by weight; and
c) the biomass comprises cells from the family of Thraustochytriaceae.

27. The method of claim 16, wherein:
a) the oxidation-sensitive material of value is DHA;
b) the silica is adjusted so that the concentration of silica in the particulate biomass is 0.5 to 2.5% by weight; and
c) the biomass comprises cells from the genera Thraustochytrium, Schizochytrium or Aurantiochytrium.

28. A particulate free-flowing biomass comprising an oxidation-sensitive material of value and silica in an amount of 0.1 to 8% by weight.

29. The particulate biomass of claim 28, wherein the silica is a hydrophilic silica with a specific surface area of 130 to 600 m²/g and a dioctyl adipate absorption value of 1.5-4.0 ml/g.

30. The particulate biomass of claim 28, wherein the silica is a hydrophobic silica with a methanol wettability of at least 40%.

31. The particulate biomass of claim 28, wherein at least 80% of particles by weight have a particle size of 100 to 3500 micrometres.

32. The particulate biomass of claim 28, wherein the biomass comprises cells from the taxon Labyrinthulomycetes.

33. The particulate biomass of claim 28, wherein:
a) the particulate biomass comprises silica in an amount of 0.2 to 6% by weight;
b) the silica is either:
i) a hydrophilic silica with a specific surface area of 130 to 600 m²/g, and a dioctyl adipate absorption value of 1.5-4.0 ml/g; or
ii) a hydrophobic silica with a methanol wettability of at least 40%;
c) at least 80% by weight of the particles have a particle size of 100 to 3500 micrometres;
d) the biomass comprises cells from the family Thraustochytriaceae.

34. The particulate biomass of claim 28, wherein:
a) the particulate biomass comprises silica in an amount of 0.5 to 2.5% by weight;
b) the silica is either:
i) a hydrophilic silica with a specific surface area of 160 to 550 m²/g, and a dioctyl adipate absorption value of 2.0 to 3.2 ml/g; or
ii) a hydrophobic silica, with a methanol wettability of at least at least 50%;
c) at least 95% by weight, of the particles have a particle size of 100 to 2500 micrometres;
d) the biomass comprises cells from the genera Thraustochytrium, Schizochytrium or Ulkenia.

35. A feedstuff or foodstuff containing the particulate biomass of claim 28 and also other feedstuff ingredients.
